(19) United States
(12) Patent Application Publication
(10) Pub. No.: US 2001/0046837 A1
(43) Pub. Date: Nov. 29, 2001

(54) Coin receivers

(76) Inventors: Terry Brown, Queensland (AU); Michael Martin, Queensland (AU)

Correspondence Address: HUDAK & SHUNK CO LPA, Suite 808, 7 Bowery Street, Akron, OH, 44308-1133, US

(21) Appl. No.: 09/832,486

(22) Filed: Apr. 11, 2001

(30) Foreign Application Priority Data
Apr. 11, 2000 (AU) PQ6833

(51) Int. Cl. G07D 1/00

(52) U.S. Cl. 453/19

(57) ABSTRACT

A coin acceptor mechanism for a coin receiving and validating apparatus, said coin acceptor mechanism comprising:

a disc-like coin pick-up wheel having a plurality of circumferentially spaced coin receiving recesses, each recess including a tapered edge portion extending at least partially about an upper edge thereof; and,

two or more radially spaced concentric reinforcing ribs extending between respective coin receiving recesses, said reinforcing ribs being adapted to resist deformation forces, in a direction orthogonal to a planar rear face, in said pick-up wheel adjacent said coin receiving recesses.

### DESCRIPTION

This invention is concerned with improvements in coin receiving and validation apparatus of the type typically employed at toll stations on tolled roadways.

The invention is concerned particularly with improvements to a coin receiving and validation apparatus as described in Australian Patent No. 645548.

The coin receiving and validation apparatus of Australian Patent No. 645548 comprises a coin acceptor mechanism having a disc-like coin receiver with spaced coin recesses about its periphery. The coin receiver is rotatably mounted on an annular base which is inclined at an angle of about 45° to vertical.

Coins or tokens of various denominations are directed to a coin hopper mounted over the lower region of the coin receiver and coins are collected in the coin recesses as the coin collector rotates. As the collector rotates it carries each coin past an electromagnetic validation sensor located in the base, the sensor being coupled to a solenoid actuated reject mechanism for rejecting invalid coins.

The specification states that the validation sensor is located intermediate the ends of a rebated channel at the uppermost region of the annular base. When the coins drop into the rebated channel they are urged past the sensor by a tapered leading edge of a rib extending from the undersurface of the coin receiver disc. The front end of each rib is tapered so that a portion of the leading edge thereof will always engage a coin, regardless of size, in the rebated channel to ensure that coins are stably held as they roll or are pushed along the rebated channel for coin validation.

The primary purpose of the rebated channel is stated to be for the stabilization of small coins as they are moved past the coin validation to ensure accurate detection. Interestingly, in practice the coin receiving and validation apparatus marketed by the patentee does not include a recessed channel and ribs on the back of the coin pick-up walls as the planar face of the coin pick-up wheel rests against the planar face of the base.

Once a coin is validated it is directed to an aperture in the annular base to fall under the influence of gravity into a coin collector.

The disc-like coin receiver or pick-up wheel and the annular base were made from a polyurethane polymer to resist wear from coins.

Although generally effective for their intended purpose, the coin receiving and validation apparatus of Australian Patent No. 645548 does however suffer a number of problems in practice.

The main problem is the inability of the apparatus to reliably handle small coins such as an Australian five cent piece or an American dime. These small coins tend to jam between the coin pick-up wheel and the annular base necessitating attention by a maintenance operator to remove the pick-up wheel to access the jammed coin. Typically clearance of a coin jammed apparatus takes about twenty minutes thus necessitating closure of the toll lane for that period.

In busy periods closure of one or more toll lanes for twenty minutes not only reduces daily toll revenue but can restrict overall traffic flow on the tollway as motorists are directed into fewer toll lanes.

Investigations have revealed that in some instances, coin jams are due to buckling of the coin pick-up wheels at ambient temperatures in excess of about 30° C. This means that coin jams are likely to be more frequent at certain times of the day, during hotter seasons or in certain geographical regions.

Another cause of coin jams results from a build up of material between the coin pick-up wheel and the annular base. Over time, a grey, greasy deposit builds up on either or both of the adjacent surfaces of the coin pick-up wheel and the annular base. This deposit comprises an abrasion residue from the polyurethane material of which the pick-up wheel and annular base are comprised and initially is derived from abrasion between coins and those elements. The abraded polyurethane material then combines with contamination from the coins to form the greasy deposit.

As the deposit layers build, this increases the friction between the polyurethane components and thus the rate of wear. This deposit build up in turn causes the peripheral edges of the pick-up wheel to warp upwardly forming a gap which can entrap small coins between the pick-up wheel and the annular base. Both the pick-up wheel and annular base are believed to be comprised of a thermoplastic polyurethane polymers.

Attempts to increase the traffic throughput in toll lanes by increasing the pick-up wheel speed above the manufacturer's recommended maximum of 37 to 38 rpm have caused thermal distortion of the coin pick-up wheel and thus coin jamming, as a direct result of increased friction between the pick-up wheel and the annular base.

The other main problem associated with the apparatus of Australian Patent No. 645548 is the cost and inconvenience in frequent replacement of worn coin pick-up wheels which typically last only about 3 to 4 months.

Apart from the periodic thermal warping due to ambient temperature conditions and/or the warping due to deposit build ups, the problem of coin jamming is exacerbated by wear in the coin pick-up wheels, which have an initial thickness of only about 2.5 mm. As the thin pick-up wheel wears, its thickness diminishes making it less resistant to thermal warping or warping due to deposit build-ups.

Even if one was to disregard the cost of the replacement pick-up wheel, the cost of replacement at frequent intervals includes toll lane downtime of about twenty minutes and the resultant loss of toll revenue.

Accordingly, there is a need to provide an improved coin pick-up wheel and annular base for the apparatus of Australian Patent No. 645548 which is less susceptible to coin jamming problems and is otherwise more durable in service.

According to one aspect of the invention there is provided a coin acceptor mechanism for a coin receiving and validating apparatus, said coin acceptor mechanism comprising:

a disc-like coin pick-up wheel having a plurality of circumferentially spaced coin receiving recesses, each recess including a tapered edge portion extending at least partially about an upper edge thereof; and

two or more radially spaced concentric reinforcing ribs extending between respective coin receiving recesses, said reinforcing ribs being adapted to resist deformation forces, in a direction orthogonal to a planar rear face, in said pick-up wheel adjacent said coin receiving recesses.

Suitably said pick-up wheel has a reinforced central portion.

Preferably said central portion is formed with a thickness greater than an annular circumferential portion in which said coin receiving recesses are located.

If required said central portion includes a plurality of radially spaced mounting apertures to resist, in use, deformation of said disc-like pick-up wheel.

Suitably said pick-up wheel includes three or more mounting apertures.

If required said pick-up wheel may be formed from a thermosetting polyurethane polymer or copolymer.

Preferably said pick-up wheel is formed from a spun cast liquid polymer.

Most preferably said pick-up wheel is comprised of an MDI urethane polymer cast in a dehumidified chamber.

The coin acceptor mechanism may also include an annular base having concentric channels in an upper surface thereof to rotatably locate said two or more radially spaced concentric reinforcing ribs of said pick-up wheel.

In order that the invention may be more fully understood and put into practical effect, reference will now be made to a preferred embodiment described in the accompanying drawings in which:

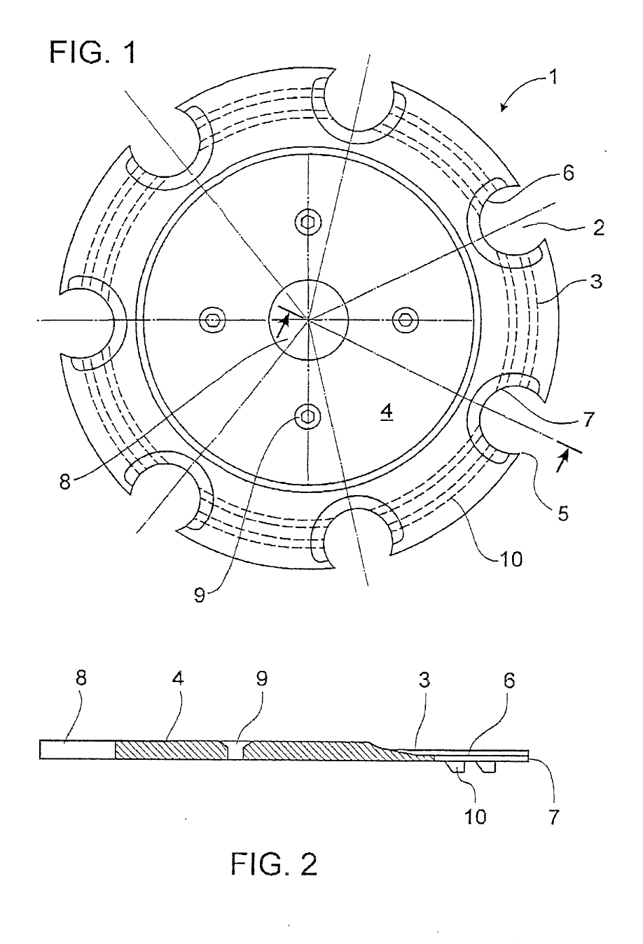

FIG. 1 shows a plan view of a coin pick-up wheel.

FIG. 2 shows a part cross sectional view of the wheel of FIG. 1.

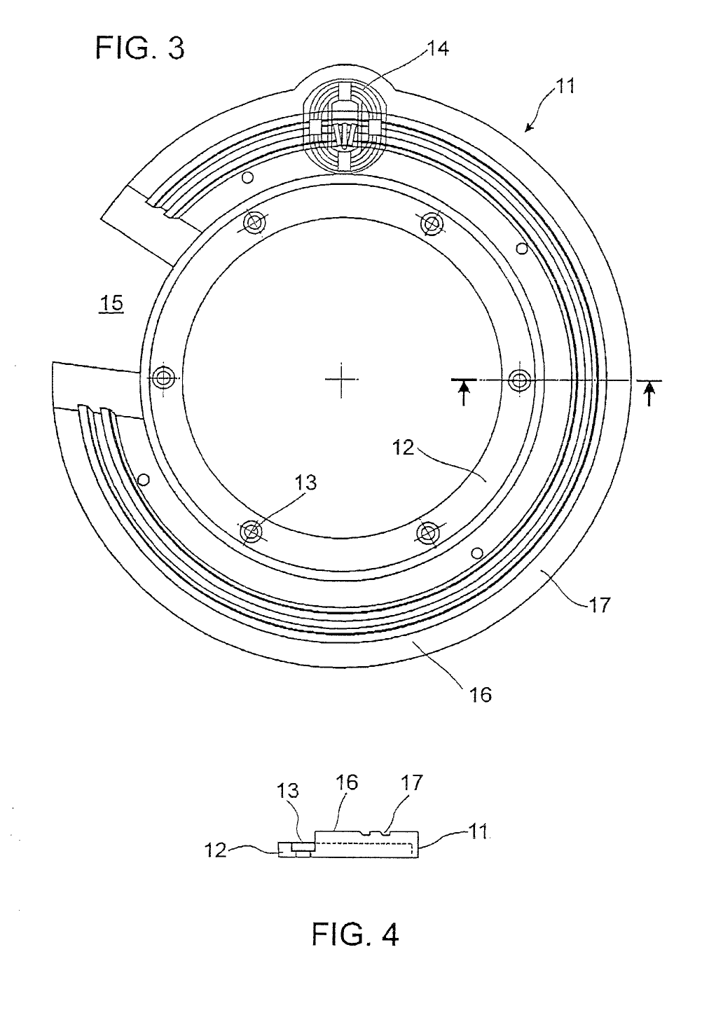

FIG. 3 shows a top plan view of an annular base for supporting the pick-up wheel.

FIG. 4 shows a cross sectional view through A-A in FIG. 3.

In FIGS. 1 and 2 the pick-up wheel 1 comprises a disc-like object with a plurality of coin receiving recesses 2 spaced circumferentially about an outer edge portion 3. The inner body portion 4 is formed as a solid section having a thickness greater than outer edge portion 3. Coin receiving recesses 2 and their respective mouths or apertures 5 are adapted to suit all coins for a given currency. For example, a pick-up wheel used in Australia would accommodate 50¢, 20¢, 10¢ and 5¢ coins.

In order to minimise the risk of coin jamming in the region of the coin hopper (not shown) when a coin located in a recess 2 is overlaid by another coin, the inner edges of recesses 2 have a tapered upper face 6 forming an upright recess edge 7 of reduced thickness.

The central body portion 4 has a central aperture 8 which locates in use over a central boss of a drive unit (not shown) and spaced screw apertures 9 to secure the disc to the drive plate (not shown) of the drive unit (also not shown). The combination of the solid central body portion and the four spaced mounting apertures 9 assist in preventing distortion of the disc-like pick-up wheel 1.

Located on the underside of the outer edge portion 3 are radially spaced reinforcing ribs 10 which also serve to resist radial curl in the disc-like pick-up wheel 1.

FIGS. 3 and 4 show an annular base member for use in conjunction with the pick-up wheel of FIGS. 1 and 2.

Base member 11 comprises an aluminium mounting plate 12 encapsulated in a thermosetting TDI polyurethane compound.

Base member 11 includes screw apertures 13 for mounting to the coin receiving and validation apparatus (not shown) an electrically energized induction coil 14 for coin validation and an exit port 15 for validated coins.

The upper face 16 of base member 11 includes a pair of concentric channels 17 having a cross sectional shape complementary to that of reinforcing ribs 10 of pick-up wheel 1. In use ribs 10 are located in channels 17 as pick-up wheel 1 rotates relative to base member 11 to transport coins from the region of the coin hopper (not shown) past the validating coil 14 and thence to the exit port 15

Surprisingly, a coin pick-up wheel made from a spun cast MDI polyurethane composition has now been in operation in a coin receiving and validation apparatus of Australian Patent No. 645548 for over fifteen months in Brisbane, Queensland without discernible wear and without a history of coin jamming from 5¢ coins regardless of ambient temperature conditions. In the absence of a coin jamming history it would appear that the build up of the grey greasy deposit which distorts the prior art coin pick-up wheels is not a concern.

Table 1 shows a comparison between the properties of the prior art thermoplastic polyurethane pick-up wheel and the thermosetting pick-up wheel according to the present invention.

TABLE 1

| PROPERTY | PRIOR ART WHEEL | | INVENTION WHEEL | |
|---|---|---|---|---|
| Polymer | Polymer “A” | | Polymer ”B” | |
| Shore D hardness | 75 | | 85 | |
| (a) Luc | | | | |
| Tensile Strength | 45 | mPa | 57 | mPa |
| IZOD Impact | | | | |
| (notched) | 37 | joule/m | 85 | joule/m |
| (un-notched) | 530 | joule/m | 480 | joule/m |

Apart from the reduced wear rate of the coin pick-up wheels according to the invention, the selection of a more wear resistant and thermally stable material in combination with a solid central portion, more than two mounting screws as with the prior art wheel and the provision of the stiffening ribs in the region of the thinner outer edge portion 3, those features either acting individually or cooperating in particular combinations to overcome all or some of the prior art coin jamming and wear problems.

Moreover, the applicant expects that the improved wear and mechanical properties of the pick-up wheels according to the invention will permit an increase in rotational speed from 37 to 45 rpm which would permit a 20% increase in toll lane traffic per day or at least a 20% increase in traffic throughput in peak periods.

The improved mechanical and wear properties combined with improved thermal stability obtainable from MDI polyurethane polymers spun cast in a dehumidified atmosphere are believed to substantially reduce the operational overheads of toll booth operations by virtually eliminating coin jams from small coins like 5¢ pieces or dimes and substantially increasing the period between replacement of worn pick-up wheels.

Still further, the invention will permit the use of coin collecting and validating apparatus of Australian Patent No. 645548 in geographic regions where use is presently denied as a result of frequent coin jamming at elevated ambient temperature conditions.

It will be readily apparent to a person skilled in the art that many modifications and variations may be made to the invention without departing rom the spirit and scope thereof.

In particular, while the applicant has exemplified the invention with reference to only one particular MDI polymer, it is considered that other MDI polymers and copolymers of differing mechanical properties may be employed for the pick-up wheel and/or the base member.

It is important however that MDI polymers be cast in the complete absence of moisture as the exothermic curing reaction causes adsorbed or absorbed moisture to form occluded cavities and/or surface imperfections which can substantially reduce the integrity of a pick-up wheel and its ability to resist wear.

Throughout this specification, unless the context requires otherwise, the word “comprise”, and variations such as “comprises” or “comprising”, will be understood to imply the inclusion of a stated integer or group of integers or steps but not the exclusion of any other integer or group of integers.

1. A coin acceptor mechanism for a coin receiving and validating apparatus, said coin acceptor mechanism comprising:
a disc-like coin pick-up wheel having a plurality of circumferentially spaced coin receiving recesses, each recess including a tapered edge portion extending at least partially about an upper edge thereof; and,
two or more radially spaced concentric reinforcing ribs extending between respective coin receiving recesses, said reinforcing ribs being adapted to resist deformation forces, in a direction orthogonal to a planar rear face, in said pick-up wheel adjacent said coin receiving recesses.

2. The coin acceptor mechanism of claim 1 wherein said pick-up wheel has a reinforced central portion.

3. The coin acceptor mechanism of claim 2 wherein said central portion is formed with a thickness greater than an annular circumferential portion in which said coin receiving recesses are located.

4. The coin acceptor mechanism of claim 3 wherein said central portion includes a plurality of radially spaced mounting apertures to resist, in use, deformation of said disc-like pick-up wheel.

5. The coin acceptor mechanism of claim 4 wherein said pick-up wheel includes three or more mounting apertures.

6. The coin acceptor mechanism of claim 5 wherein said pick-up wheel may be formed from a thermosetting polyurethane polymer or copolymer.

7. The coin acceptor mechanism of claim 5 wherein said pick-up wheel is formed from a spun cast liquid polymer.

8. The coin acceptor mechanism of claim 5 wherein said pick-up wheel is comprised of an MDI urethane polymer cast in a dehumidified chamber.

9. The coin acceptor mechanism of claim 5 further comprising an annular base having concentric channels in an upper surface thereof to rotatably locate said two or more radially spaced concentric reinforcing ribs of said pick-up wheel.
